(19) United States
(12) Patent Application Publication
(10) Pub. No.: US 2025/0328327 A1
(43) Pub. Date: Oct. 23, 2025

(54) Code Offloading based on Processing-in-Memory Suitability

(71) Applicant: Advanced Micro Devices, Inc., Santa Clara, CA (US)

(72) Inventors: Sangeeta Chowdhary, Sunnyvale, CA (US); Bodhisatwa Chatterjee, Middletown, NJ (US)

(73) Assignee: Advanced Micro Devices, Inc., Santa Clara, CA (US)

(21) Appl. No.: 18/638,383

(22) Filed: Apr. 17, 2024

(51) Int. Cl. G06F 8/41

(52) U.S. Cl. CPC G06F 8/4434; G06F 8/433

(57) ABSTRACT

A device includes a memory having one or more processing-in-memory units, a processor core, and a compiler executing on the processor core. The compiler causes the processor core to compile source code of a software program. As part of this, the processor core marks a portion of the source code as suitable for execution using the one or more processing-in-memory units. Based on the marking, the processor core offloads the portion of the source code for execution by the one or more processing-in-memory units.

### BACKGROUND

Processing-in-memory (PIM) architectures move processing of memory-intensive computations to memory. This contrasts with standard computer architectures which communicate data back and forth between a memory and a remote processing unit. In terms of data communication pathways, remote processing units of conventional computer architectures are further away from memory than PIM units. As a result, these conventional computer architectures suffer from increased data transfer latency, which can decrease overall computer performance. Further, due to the proximity to memory, PIM architectures can also provision higher memory bandwidth and reduced memory access energy relative to conventional computer architectures particularly when the volume of data transferred between the memory and the remote processing unit is large. Thus, PIM architectures enable increased computer performance while reducing data transfer latency as compared to conventional computer architectures that implement remote processing hardware.

### BRIEF DESCRIPTION OF THE DRAWINGS

FIG. 1 is a block diagram of a non-limiting example system to implement code offloading based on processing-in-memory suitability.

FIG. 2 depicts a non-limiting example system showing operation of a compiler to mark a portion of source code of a software program as suitable for processing-in-memory execution.

FIG. 3 depicts a non-limiting example showing operation of a compiler to generate a linked read dependence graph.

FIG. 4 depicts a procedure in an example implementation of code offloading based on processing-in-memory suitability.

### DETAILED DESCRIPTION

### Overview

A device includes a host processor having a processor core communicatively coupled to a memory module having a memory and one or more processing-in-memory (PIM) units. Offloading memory bound computations for execution by the PIM units enables improved computational efficiency by way of reducing data transfer latency and increasing memory bandwidth relative to processing data in the memory using the host processor. However, not all workloads are compatible with the PIM architecture. Indeed, a workload offloaded for PIM execution that does not comply with certain PIM compatibility conditions often fails to preserve functionally correct execution of the workload and/or reduces computational efficiency for the workload, e.g., such that processing the workload using the host processor is faster and/or more computationally efficient.

Accordingly, compiler-implemented techniques are described herein for determining whether code portions are suitable for execution by the PIM units. To do so, the compiler receives a code portion (e.g., a portion of source code of a software program) and determines whether the code portion is bank localizable. In various implementations, the PIM units are each communicatively coupled to a same number of one or more banks. As such, a respective PIM unit is capable of directly accessing the one or more banks to which the PIM unit is communicatively coupled, e.g., due to a lack of inter-bank communication functionality in various memory architectures. Given this, the compiler determines that the code portion is bank localizable based on sets of interdependent data elements accessed by the code portion being storable within the number of banks communicatively coupled to respective ones of the PIM units.

In addition, the compiler determines whether the code portion invokes an amount of data duplication that preserves improved computational efficiency (relative to host-based execution). In one or more implementations, data elements accessed by the code portion are often operated on by multiple PIM units. Since the PIM units are capable of directly accessing banks that are local to the PIM units, executing the code portion using the PIM units often invokes data duplication, e.g., storing a data element in different banks accessible by different PIM units. However, excessive amounts of data duplication invoked by a code portion reduce computational efficiency for the device, e.g., due to more row open operations to execute the code portion. Accordingly, the compiler determines that the code portion is suitable for execution using the PIM units based on an amount of data duplication invoked by the code portion falling below a threshold amount of data duplication.

Furthermore, the compiler determines whether the code portion is parallelizable. Processing-in-memory often exploits data-level parallelism which, in the context of PIM, means that multiple PIM units perform a same set of operations on different data stored in corresponding memory locations in parallel. Thus, the compiler determines that the code portion is parallelizable if the data accessed by the code portion is distributable across the banks of the memory in a way that enables the different PIM units to process the data concurrently.

Moreover, the compiler determines whether the code portion enables column alignment. Processing-in-memory often exploits vector processing, which in the context of PIM, means that a PIM unit performs a same set of operations on different data stored in different columns of the banks operated on by the PIM unit. Accordingly, sets of interacting elements of the code portion that are operated on together (e.g., accumulated together, multiplied together, etc.) as part of a single computation are to be stored in respective columns of the banks. Given this, the compiler determines that the code portion enables column alignment if a largest number of interacting elements of the code portion are storable within a single column of the one or more banks operated on by respective ones of the PIM units.

The compiler marks the code portion as suitable for execution using the PIM units based on the code portion being identified as parallelizable, bank localizable, enabling column alignment, and invoking a suitable amount of data duplication. In contrast, the compiler marks the code portion as not suitable for execution using the PIM units based on the code portion being identified as not parallelizable, not bank localizable, not enabling column alignment, or invoking an excessive amount of data duplication. During an execution phase, the host processor offloads the code portion for execution using the PIM units if the code portion is marked as suitable for PIM execution, or the host processor executes the code portion if the code portion is marked as not suitable for PIM execution.

Conventional techniques rely on a programmer to identify code portions suitable for PIM offloading, which is time consuming for the programmer and often results in PIM-incompatible code portions being identified for PIM offloading. As a result, conventional PIM offloading techniques often produce functionally incorrect results and/or reduce computational efficiency for the device. In contrast, the described techniques prevent code portions from being executed using PIM if doing so would produce functionally incorrect results or reduced computational efficiency relative to host-based execution. Accordingly, the described techniques improve functional correctness of PIM execution and improve computational efficiency relative to conventional techniques, while relieving the programmer of the time consuming task of manually identifying code portions for PIM offloading.

In some aspects, the described techniques relate to a device, comprising a memory that includes one or more processing-in-memory units, a processor core, and a compiler executing on the processor core, the compiler causing the processor core to perform operations including compiling source code of a software program, during the compiling, marking a portion of the source code as suitable for execution using the one or more processing-in-memory units, and offloading the portion of the source code for execution by the one or more processing-in-memory units based on the marking.

In some aspects, the described techniques relate to a device, the operations further including generating a data dependence graph based on the portion of the source code, wherein the marking is based on an absence of cycles in the data dependence graph that include at least one loop-carried true dependency.

In some aspects, the described techniques relate to a device, wherein a cycle includes the at least one loop-carried true dependency based on a read access that is performed during a subsequent iteration of the cycle being dependent on a write access that is performed during a previous iteration of the cycle.

In some aspects, the described techniques relate to a device, wherein the portion of the source code accesses a first data structure and a second data structure, the operations further including generating a first read dependence graph representing one or more first chains of dependent elements of the first data structure based on the portion of the source code, generating a second read dependence graph representing one or more second chains of dependent elements of the second data structure based on the portion of the source code, and generating a linked read dependence graph representing one or more linked chains of dependent elements by linking the one or more first chains with the one or more second chains based on the portion of the source code.

In some aspects, the described techniques relate to a device, wherein the marking is based on a memory capacity of a first number of banks communicatively coupled to respective ones of the one or more processing-in-memory units being greater than or equal to an amount of the memory to store a second number of elements represented by a longest chain of the one or more linked chains.

In some aspects, the described techniques relate to a device, wherein the marking is based on a duplication metric falling below a threshold, the duplication metric capturing an amount of data duplication in the memory to execute the portion of the source code using the one or more processing-in-memory units.

In some aspects, the described techniques relate to a device, the operations further including computing the duplication metric based on a comparison of a first number of elements, including duplicated elements, represented by the linked read dependence graph to a second number of unique elements represented by the linked read dependence graph.

In some aspects, the described techniques relate to a device, wherein the marking is based on a first number of rows in a second number of banks communicatively coupled to respective ones of the one or more processing-in-memory units being greater than or equal to a maximum number of interacting elements of the linked read dependence graph.

In some aspects, the described techniques relate to a device, wherein the maximum number of interacting elements includes an element of the linked read dependence graph and one or more elements directly connected to the element in the linked read dependence graph, the element having a highest number of elements directly connected thereto in the linked read dependence graph.

In some aspects, the described techniques relate to a device, the operations further including during the compiling, marking an additional portion of the source code as not suitable for execution using the one or more processing-in-memory units, and executing the portion of the source code based on the portion of the source code being marked as not suitable for execution using the one or more processing-in-memory units.

In some aspects, the described techniques relate to a method, comprising compiling a portion of source code of a software program, during the compiling, generating a read dependence graph representing one or more chains of dependent elements of one or more data structures accessed by the portion of the source code, and offloading the portion of the source code for execution by one or more processing-in-memory units based on a memory capacity of a number of banks communicatively coupled to respective ones of the one or more processing-in-memory units being greater than or equal to an amount of memory to store a number of elements represented by a longest chain of the one or more chains.

In some aspects, the described techniques relate to a method, wherein the portion of the source code accesses a first data structure and a second data structure, wherein generating the read dependence graph includes generating a first read dependence graph representing one or more first chains of dependent elements of the first data structure based on the portion of the source code, generating a second read dependence graph representing one or more second chains of dependent elements of the second data structure based on the portion of the source code, and generating the read dependence graph representing the one or more chains of dependent elements by linking the one or more first chains with the one or more second chains based on the portion of the source code.

In some aspects, the described techniques relate to a method, further comprising computing a duplication metric capturing an amount of data duplication in the memory to execute the portion of the source code using the one or more processing-in-memory units, wherein offloading the portion of the source code is further based on the duplication metric falling below a threshold.

In some aspects, the described techniques relate to a method, wherein the duplication metric is based on a comparison of a first number of elements, including duplicated elements, represented by the read dependence graph to a second number of unique elements represented by the read dependence graph.

In some aspects, the described techniques relate to a method, further comprising generating a data dependence graph based on the portion of the source code, and verifying an absence of cycles in the data dependence graph that include at least one loop-carried true dependency, wherein offloading the portion of the source code is further based on the verifying.

In some aspects, the described techniques relate to a method, wherein a cycle includes the at least one loop-carried true dependency based on a read access that is performed during a subsequent iteration of the cycle being dependent on a write access that is performed during a previous iteration of the cycle.

In some aspects, the described techniques relate to a method, further comprising verifying that an additional number of rows in the number of banks is greater than or equal to a maximum number of elements that are operated on together in a single computation of the portion of the source code based on the read dependence graph, wherein offloading the portion of the source code is further based on the verifying.

In some aspects, the described techniques relate to a system, comprising a memory that includes one or more processing-in-memory units, and a processor core to perform operations including compiling a portion of source code of a software program, during the compiling, computing a duplication metric capturing an amount of data duplication in the memory to execute the portion of the source code using the one or more processing-in-memory units, and offloading the portion of the source code for execution by the one or more processing-in-memory units based on the duplication metric falling below a threshold.

In some aspects, the described techniques relate to a system, wherein the portion of the source code accesses at least one data structure, the operations further including generating a read dependence graph representing one or more first chains of dependent elements of the at least one data structure based on the portion of the source code, and generating, using a graph partitioning algorithm, one or more second chains of dependent elements of the at least one data structure by partitioning the one or more first chains.

In some aspects, the described techniques relate to a system, wherein computing the duplication metric is based on a comparison of a first number of elements, including duplicated elements, represented by the one or more second chains to a second number of unique elements represented by the one or more second chains.

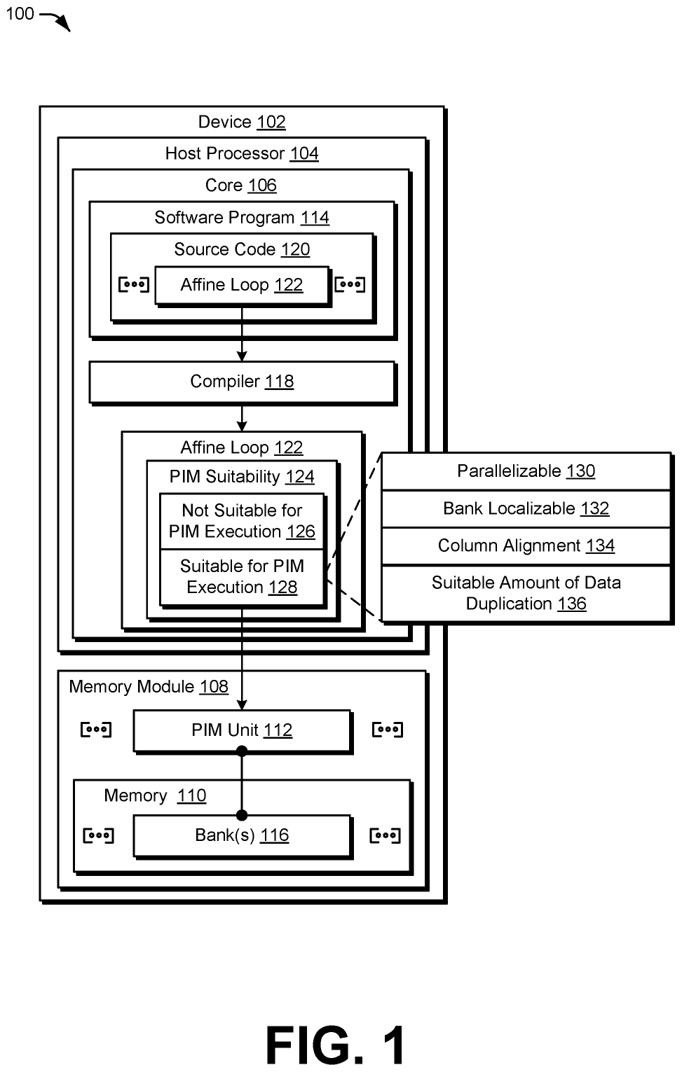

FIG. 1 is a block diagram of a non-limiting example system 100 to implement code offloading based on processing-in-memory suitability. The system 100 includes a device 102 having a host processor 104 with a core 106, and a memory module 108 having a memory 110 and a plurality of processing-in-memory (PIM) units 112.

In accordance with the described techniques, the host processor 104 and the memory module 108 are coupled to one another via one or more wired or wireless connections. Example wired connections include, but are not limited to, buses (e.g., a data bus), interconnects, traces, and planes. Examples of the device 102 include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

The host processor 104 is an electronic circuit that performs various operations on and/or using data in the memory 110. Examples of the host processor 104 and/or the core 106 include, but are not limited to, a central processing unit (CPU), a graphics processing unit (GPU), an application specific integrated circuit (ASIC), and a field programmable gate array (FPGA). For example, the core 106 is a processing unit that reads and executes requests and/or instructions (e.g., of software programs 114), examples of which include to add data, to move data, and to branch. Example software programs 114 running on the core 106 of the host processor 104 include operating systems and software applications. Although one core 106 is depicted in the example system 100, the host processor 104 includes more than one core 106 in variations, e.g., the host processor 104 is a multi-core processor.

In one or more implementations, the memory module 108 is a circuit board (e.g., a printed circuit board), on which the memory 110 is mounted and includes the PIM units 112. Examples of the memory module 108 include, but are not limited to, a TransFlash memory module, a single in-line memory module (SIMM), and a dual in-line memory module (DIMM). In one or more implementations, the memory module 108 is a single integrated circuit device that incorporates the memory 110 and the PIM units 112 on a single chip. In some examples, the memory module 108 is composed of multiple chips that implement the memory 110 and the PIM units 112 that are vertically (“3D”) stacked together, are placed side-by-side on an interposer or substrate, or are assembled via a combination of vertical stacking or side-by-side placement.

The memory 110 is a device or system that is used to store information, such as for immediate use in a device, e.g., by the core 106 of the host processor 104 and/or by the PIM units 112. In one or more implementations, the memory 110 corresponds to semiconductor memory where data is stored within memory cells on one or more integrated circuits. In at least one example, the memory 110 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 110 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). Thus, the memory 110 is configurable in a variety of ways that support code offloading based on processing-in-memory suitability without departing from the spirit or scope of the described techniques.

Broadly, the PIM units 112 correspond to in-memory processors, e.g., embedded within the memory module 108. The in-memory processors are implemented with example processing capabilities ranging from relatively simple (e.g., for performing addition, comparison, maximum, and/or minimum operations) to relatively complex, e.g., a CPU/GPU compute core. Broadly, the host processor 104 is configured to offload memory bound computations to the PIM units 112. To do so, the host processor 104 generates PIM requests (e.g., by the core 106) and transmits the PIM requests to the memory module 108. The PIM units 112 receive the PIM requests and process the PIM requests utilizing data stored in the memory 110. More specifically, a respective PIM unit 112 is communicatively coupled to a set of one or more banks 116 of the memory 110, as shown, and the respective PIM unit 112 processes PIM requests utilizing data stored in the set of one or more banks 116 to which it is communicatively coupled. In other words, a PIM unit 112 “operates on” the one or more banks 116 to which the PIM unit 112 is communicatively coupled.

While the PIM units 112 are illustrated as being disposed within the memory module 108, it is to be appreciated that in some examples, the described benefits of code offloading based on processing-in-memory suitability are realizable through near-memory processing implementations. In accordance with these implementations, one or more of the PIM units 112 are disposed outside of the memory module 108, but are closer in proximity to the memory 110 (e.g., in terms of data communication pathways and/or topology) than the core 106 of the host processor 104.

Processing-in-memory using in-memory processors contrasts with processing data using the host processor 104. Indeed, processing data in memory 110 using the host processor 104 (e.g., host-based execution) involves communicating data from the memory 110 to the core 106 of the host processor 104, and processing the data using the core 106 rather than the PIM units 112. In various scenarios, the data produced by the core 106 as a result of processing the obtained data is written back to the memory 110, which involves communication of the data back to the memory 110. In terms of data communication pathways, the core 106 is further away from the memory 110 than the PIM units 112. Given this, processing data using the PIM units 112 enables increased computational efficiency by way of reducing data transfer energy and increasing memory bandwidth, as compared to processing data in memory 110 using the host processor 104. Additionally, processing data using the PIM units 112 alleviates memory performance and energy bottlenecks by moving memory intensive computations closer to memory 110.

However, not all workloads are compatible with the PIM architecture. For example, a workload offloaded for execution by the PIM units 112 only produces functionally correct results while increasing computational efficiency (e.g., in comparison to executing the workload using the host processor 104) if the workload exhibits certain attributes. Here, “functionally correct execution” by the PIM units 112 refers to the notion that the PIM units 112 process the workload to generate results that are correct, e.g., the same results as would be produced if the workload were processed by the host processor 104. It follows that “functionally incorrect execution” by the PIM units 112 refers to the notion that the PIM units 112 process the workload to generate results that are incorrect, e.g., inconsistent with the results that would be produced if the workload were processed by the host processor 104.

Accordingly, the described techniques provide functionality for predicting whether a workload is suitable for offloading to the PIM units 112 for execution. To do so, the host processor 104 includes a compiler 118, which represents software that runs on the core 106 to translate (e.g., compile) source code 120 of a software program 114 from a high-level source programming language into machine code, byte code, or some other low-level programming language that is executable by hardware components of the system 100. It should be noted that operations are described herein as being performed by the compiler 118, but it is to be appreciated that these operations are, in fact, performed by the core 106 during a compilation phase as a result of executing the compiler 118.

As shown, the compiler 118 receives an affine loop 122 of the source code 120. A loop is a sequence of one or more instructions of the source code 120 that are continually repeated until a certain condition is reached, examples of which include “for” loops, “while” loops, and “do-while” loops. An affine loop 122, thus, is a loop in which loop bounds and loop increments are expressed as affine transformations of the loop variable.

Broadly, the compiler 118 is configured to analyze the affine loop 122 and mark the affine loop 122 with an indication of PIM suitability 124 based on whether the affine loop 122 is determined to be suitable for execution using the PIM units 112. For example, in response to predicting that executing the affine loop 122 using the PIM units 112 will result in functionally incorrect execution and/or decreased computational efficiency relative to host-based execution, the compiler 118 marks the affine loop 122 as not suitable for PIM execution 126. Alternatively, the compiler 118 marks the affine loop 122 as suitable for PIM execution 128 in response to predicting that executing the affine loop 122 using the PIM units 112 will result in functionally correct execution and increased computational efficiency relative to host-based execution.

To predict suitability for PIM execution, the compiler 118 determines whether the affine loop 122 is parallelizable 130. Notably, processing-in-memory often exploits data-level parallelism, which in the context of PIM, means that multiple PIM units 112 perform a same set of operations on different data in parallel. To execute a single PIM request, for example, a first PIM unit 112 performs a set of operations on data stored in a memory location (e.g., a particular row and a particular column) of a bank 116 operated on by the first PIM unit 112, concurrently while a second PIM unit 112 performs the same set of operations on different data stored in a corresponding memory location (e.g., the particular row and the particular column) of a different bank 116 operated on by the second PIM unit 112. Thus, the compiler 118 determines that the affine loop 122 is parallelizable 130 if data accessed by the affine loop 122 is distributable across the banks 116 of the memory 110 in a way that enables the different PIM units 112 to process the data concurrently.

Furthermore, the compiler 118 determines whether the affine loop 122 is bank localizable 132. Notably, a PIM unit 112 is capable of directly accessing (e.g., reading data from and writing data to) bank(s) 116 that are local to the PIM unit 112, e.g., the bank(s) 116 to which the PIM unit 112 is communicatively coupled. In order to access data in non-local banks 116, however, the host processor 104 facilitates the access, e.g., due to a lack of inter-bank communication substrate in various memory architectures. Host-facilitated accesses of data involve communication of data from the memory 110 (e.g., the non-local bank 116) to the host processor 104, and from the host processor 104 back to the memory 110 (e.g., the local bank 116). These host-facilitated accesses, thus, thwart the performance benefits of processing-in-memory as data is communicated to and from the memory 110 and the host processor 104, similar to processing data in memory 110 using the core 106.

In one or more implementations, the affine loop 122 exhibits dependencies between data elements accessed by the affine loop 122. For example, accessing a data element (e.g., reading or writing the data element) in accordance with the affine loop 122, involves first accessing a different data element (e.g., reading or writing the different data element). Given this, a set of interdependent data elements accessed by the affine loop 122 is to be stored in a set of bank(s) 116 operated on by one PIM unit 112. By doing so, the PIM units 112 are prevented from accessing non-local banks 116, thereby eliminating the aforementioned host-facilitated data accesses. Therefore, the compiler 118 determines that the affine loop 122 is bank localizable 132 if the memory capacity of a number of bank(s) 116 communicatively coupled to respective ones of the PIM units 112 is sufficient to store respective sets of interdependent data elements accessed by the affine loop 122.

In addition, the compiler 118 determines whether the affine loop 122 enables column alignment 134. Processing-in-memory often exploits vector processing, which in the context of PIM, means that a single PIM unit 112 performs the same set of operations on different data in parallel. In order to carry out a single PIM request, for example, a PIM unit 112 performs a set of operations on data stored in a first column of a bank 116 operated on by the PIM unit 112, the same PIM unit 112 also performs the same set of operations on different data stored in a second column of the bank 116 operated on by the PIM unit 112, and so on. Column alignment 134, therefore, refers to the notion that different sets of interacting data elements that are operated on together (e.g., accumulated together, multiplied together, etc.) as part of a single computation are stored in different columns of the memory 110 to enable parallel vector processing. Therefore, the compiler 118 determines that the affine loop 122 enables column alignment 134 if a maximum number of interacting data elements of the affine loop 122 fit within a single column of the bank(s) 116 operated on by a respective PIM unit 112

Moreover, the compiler 118 determines whether the affine loop 122 invokes a suitable amount of data duplication 136. As previously mentioned, a PIM unit 112 directly accesses bank(s) 116 that are local to the PIM unit 112, but accesses non-local bank(s) 116 via host-facilitated accesses. In various scenarios, a data element is accessed by different PIM units 112. Thus, to prevent host-facilitated data accesses, the data element is duplicated across different banks 116 operated on by different PIM units 112. The suitable amount of data duplication 136, therefore, refers to an amount of data duplication that enables the PIM units 112 to process the affine loop 122 while increasing computational efficiency relative to host-based execution of the affine loop 122.

By way of example, the number of row open operations to execute the affine loop 122 increases as the amount of data duplication increases. Since opening a row of the memory 110 is a relatively costly operation, excessive amounts of data duplication can significantly reduce computational efficiency for the device 102. Accordingly, the compiler 118 determines that the affine loop 122 involves a suitable amount of data duplication 136 that renders the affine loop 122 suitable for PIM execution 128 based on the amount of data duplication invoked by the affine loop 122 falling below a threshold.

Based on determining that the affine loop 122 is parallelizable 130, bank localizable 132, enables column alignment 134, and invokes the suitable amount of data duplication 136, the compiler 118 marks the affine loop 122 as suitable for PIM execution 128. If, however, the compiler 118 determines that the affine loop 122 is not parallelizable 130, not bank localizable 132, prevents column alignment 134, or invokes an excessive amount of data duplication, the compiler 118 marks the affine loop 122 as not suitable for PIM execution 126.

If the affine loop 122 is marked as not suitable for PIM execution 126 during the compilation phase, the core 106 processes the affine loop 122 during the execution phase, i.e., without offloading the affine loop 122 for execution using the PIM units 112. However, if the affine loop 122 is marked as suitable for PIM execution 128 during the compilation phase, the core 106 offloads the affine loop 122 for execution by the PIM units 112 during the execution phase. In other words, the core 106 of the host processor 104 prevents portions of source code 120 from being executed by the PIM units 112 if doing so would produce functionally incorrect results or reduced computational efficiency relative to host-based execution of the portions of the source code 120.

Conventional techniques for PIM offloading rely on a programmer (e.g., of the source code 120) to identify which portions of the source code 120 are capable of being offloaded to the PIM units 112. Not only are these techniques time-consuming for the programmer, but code portions are often wrongly identified as suitable for offloading to the PIM units 112, particularly when the code portions are large and/or complex. In these scenarios, executing the source code 120 in the system 100 produces incorrect results and reduces computational efficiency for the device 102. In contrast, the described techniques, produce functionally correct results using the PIM units 112, increase computational efficiency for the device 102, and relieve the programmer of the time-consuming task of manually identifying code portions for offloading to the PIM units 112.

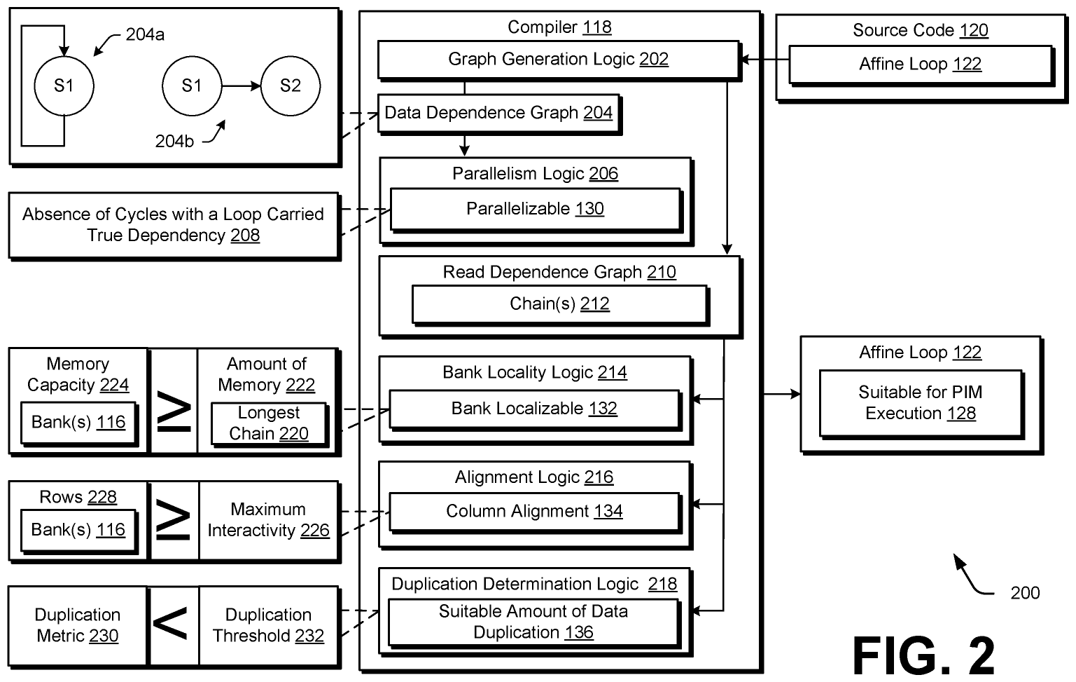

FIG. 2 depicts a system 200 in an example implementation showing operation of a compiler to mark a portion of source code of a software program as suitable for processing-in-memory execution. As shown, the affine loop 122 is provided as input to graph generation logic 202 of the compiler 118. In one or more implementations, the graph generation logic 202 is configured to generate a data dependence graph 204 based on the affine loop 122. Broadly, the data dependence graph 204 includes nodes that represent processing tasks of the affine loop 122, and edges that represent dependencies between the processing tasks. Notably, the dependencies represented by the edges of the data dependence graph 204 include read dependencies and/or write dependencies.

Parallelism logic 206 of the compiler 118 receives the data dependence graph 204, and determines whether the affine loop 122 is parallelizable 130. To do so, the parallelism logic 206 determines whether there are any cycles in the data dependence graph 204 that include at least one loop-carried true dependency. A cycle is a closed loop in the data dependence graph 204. In other words, the data dependence graph 204 includes a cycle if following the edges of the data dependence graph 204 from a starting node eventually leads back to the starting node. Further, a true dependency refers to a scenario in which a data element is written to a memory location and subsequently read from the memory location, e.g., also known as a read-after-write dependency. Moreover, a dependency is “loop-carried” if a value accessed in one iteration of the affine loop 122 is used in a subsequent iteration of the affine loop 122. Therefore, a cycle having a “loop-carried true dependency” refers to a scenario in which a read access performed during a subsequent iteration of the cycle is dependent on a write access that is performed during a previous iteration of the cycle.

Consider the following as an example of an affine loop 122 that is not parallelizable 130:

$$for ( int i = 1 ; i < N ; i ++ )$$

$$S 1 : A [ i ] = A [ i - 1 ]$$

In this example, A is representative of a data structure. An example data dependence graph 204a for the example affine loop 122 is shown in FIG. 2 As shown, the data dependence graph 204a includes a cycle in statement S1, e.g., due to accesses (e.g., read and/or write accesses) performed in a subsequent iteration of the statement being dependent on accesses (e.g., read and/or write accesses) performed in previous iterations of the statement. Further, the cycle of the affine loop 122 includes a loop-carried true dependency. For example, memory location A [0] is read and written to memory location A [1] in iteration [1], and memory location A [1] (after having been written in iteration [1]) is read and written to memory location A [2] in iteration [2]. In other words, the read access to memory location A [1] in a subsequent iteration [2] is only performable after (e.g., is dependent on) a write access to memory location A [1] that is performed in a previous iteration [1]. Since the example affine loop 122 includes a cycle having a loop-carried true dependency, the affine loop 122 is not parallelizable.

Consider the following affine loop 122 as a contrasting example of an affine loop 122 that is parallelizable 130:

$$for ( int i = 1 ; i < N ; i ++ )$$

$$S 1 : A [ i + 2 ] = B [ i ]$$

$$S 2 : C [ i ] = A [ i ] + i$$

In this example, A, B, and C represent different data structures. An example data dependence graph 204b for the example affine loop 122 is shown in FIG. 2. Notably, the data dependence graph 204b includes a loop-carried true dependency between statements, S1 and S2. This is because read accesses to memory location A [i] in a subsequent iteration [i] are only performable after (e.g. are dependent on) write accesses to A [i+2] in a previous iteration [i−2]. However, there are no cycles in the data dependence graph 204b, as shown, and as such, the affine loop 122 is parallelizable 130. In this scenario, the compiler 118 breaks the dependency between statements, S1 and S2, thereby creating two different affine loops 122-one having statement, S1, and another having statement, S2. Thus, during the execution phase, the compiler 118 offloads a first affine loop 122 including statement S1 to a first PIM unit 112, and offloads a second affine loop 122 including statement S2 to a second PIM unit 112.

Practically, loop-carried true dependencies prevent data-level parallelism because the dependencies between different iterations of an affine loop 122 create a sequential order of execution, thereby preventing the different iterations from being performed in parallel. However, loop-carried true dependencies between processing tasks (e.g., statements), in the absence of a cycle, are breakable, and the different processing tasks are independently processible as independent affine loops 122. Therefore, the compiler 118 mitigates the sequential order of execution imposed by a loop-carried true dependency without a cycle by breaking the dependencies between processing tasks (e.g., statements), thereby causing the different processing tasks to be processed by different PIM units 112 during the execution phase.

In summary, the parallelism logic 206 determines that the affine loop 122 is parallelizable 130 based on verifying an absence of cycles with a loop-carried true dependency 208. In other words, the affine loop 122 is not parallelizable 130 if (1) the data dependence graph includes cycles, and (2) at least one cycle includes a loop-carried true dependency. In contrast, the affine loop 122 is parallelizable 130 if (1) the data dependence graph 204 does not include cycles, or (2) the data dependence graph 204 includes cycles, but the cycles do not include a loop-carried true dependency. In the scenario in which the affine loop 122 includes a loop-carried true dependency without a cycle, the compiler 118 breaks the dependency between multiple processing tasks during the compilation phase, thereby creating multiple affine loops 122 and causing the multiple affine loops 122 to be independently offloaded to different PIM units 112. In one or more implementations, data-level parallelism is enabled for affine loops 122 having cycles without loop-carried true dependencies using any one of a variety of compiler-implemented techniques, such as, variable renaming, register renaming, scalar expansion, and so on.

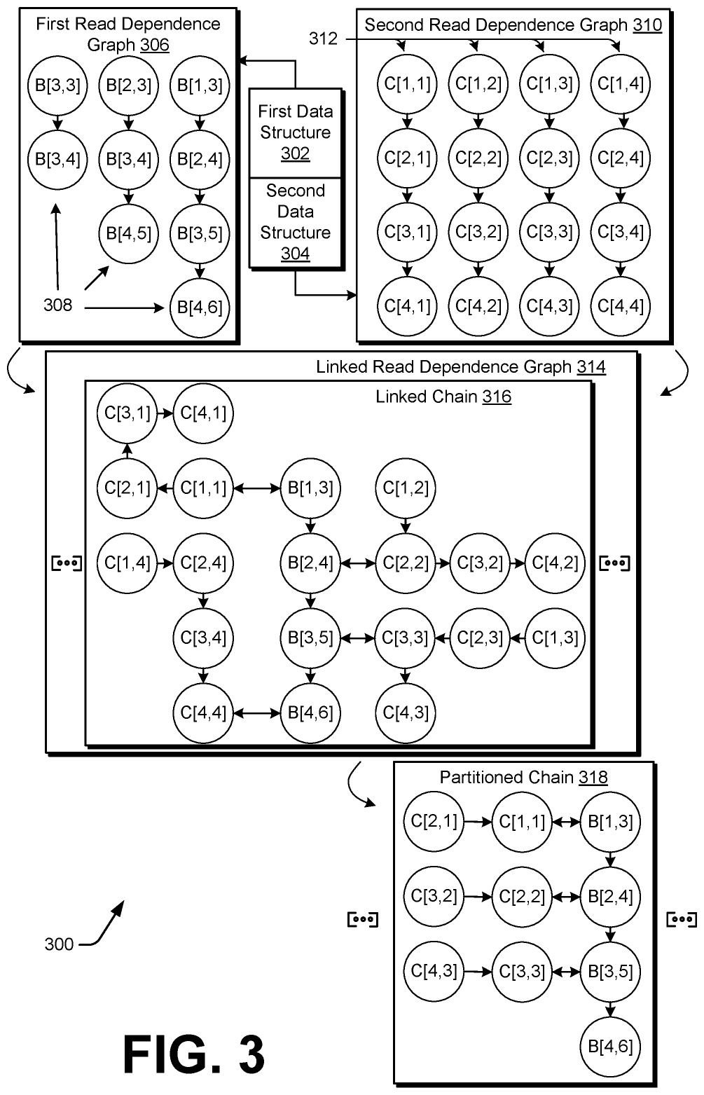

As shown, the graph generation logic 202 additionally generates a read dependence graph 210. For example, the affine loop 122 accesses one or more data structures in memory 110, and the read dependence graph 210 includes nodes representing data elements of the one or more data structures accessed by the affine loop 122, and edges representing dependencies between the data elements. In contrast to the data dependence graph 204, the dependencies represented by the edges of the read dependence graph 210 include read dependencies only, e.g., and not write dependencies. As shown, the read dependence graph 210 includes one or more chains 212 of interdependent data elements, e.g., one or more data elements that are (directly or indirectly) dependent on one another. Generation of the read dependence graph 210 and the chains 212 is further discussed below with reference to FIG. 3

FIG. 3 depicts a non-limiting example 300 showing operation of a compiler to generate a linked read dependence graph. In the example 300, the graph generation logic 202 of the compiler 118 generates a read dependence graph 210 for the following affine loop 122:

$$for ( int i = 0 ; i < N ; i ++ )$$

$$for ( int j = 0 ; j < N ; j ++ )$$

$$S 1 : A [ i ] [ i ] = B [ i + 1 ] [ j + 3 ] + B [ i + 2 ] [ j + 4 ] + C [ i + 1 ] [ j + 1 ] + C [ i + 2 ] [ j + 1 ]$$

Here, the affine loop 122 accesses a first data structure 302, B, and a second data structure 304, C.

In accordance with the described techniques, the graph generation logic 202 generates a first read dependence graph 306 representing first chains 308 of dependent elements of the first data structure 302 based on the affine loop 122. For example, the first read dependence graph 306 includes nodes representing data elements of the first data structure 302, and edges representing read dependencies between the data elements. To generate the first read dependence graph 306, the graph generation logic 202 determines a first read distance vector by computing a difference between different accesses of the first data structure 302 in the affine loop 122. By way of example, the first read distance vector is representable as:

$$\vec{d} B = ( B [ i + 2 ] [ j + 4 ] ) - ( B [ i + 1 ] [ j + 3 ] ) = ( 1 , 1 )$$

Furthermore, the graph generation logic 202 generates the first chains 308 by linking dependent data elements of the first data structure 302 based on the first read distance vector. As part of this, the graph generation logic 202 identifies an element of the first data structure 302. For example, the operand B[i+1] [j+3] for loop increments i=0 and j=0 produces element B[1,3]. Further, the graph generation logic 202 identifies data elements depending from the identified element, B[1,3], based on the read distance vector. To do so, the graph generation logic 202 iteratively accumulates an element identifier of the identified element with the first read distance vector, e.g., the element identifier of element B[1,3] is (1,3). By way of example, B[1,3] is antecedent on (1,3)+ (1,1)=B[2,4], which is antecedent on (2,4)+ (1,1)=B[3,5], which is antecedent on (3,5)+ (1,1)=B[4,6], as shown. This process is repeated on different identified elements, e.g., B[2,3] based on the operand B[i+1] [j+3] and loop increments i=1 and j=0, and B[3,3] based on the operand B[i+1] [j+3] and loop increments i=2 and j=0, as shown.

In addition, the graph generation logic 202 generates a second read dependence graph 310 representing second chains 312 of dependent elements of the second data structure 304 based on the affine loop 122. For example, the second read dependence graph 310 includes nodes representing data elements of the second data structure 304, and edges representing read dependencies between the data elements. Further, the graph generation logic 202 determines a second read distance vector by computing a difference between different accesses of the second data structure 304 in the affine loop 122. The second read distance vector is representable as:

$$\vec{d} C = ( C [ i + 2 ] [ j + 1 ] ) - ( C [ i + 1 ] [ j + 1 ] ) = ( 1 , 0 )$$

Here, the graph generation logic 202 generates the second chains 312 by linking dependent data elements of the second data structure 304 based on the second read distance vector, e.g., in accordance with the techniques discussed above with respect to the first read dependence graph 306.

Furthermore, the graph generation logic 202 generates a linked read dependence graph 314 representing one or more linked chains 316 of dependent elements of the first data structure 302 and the second data structure 304. To generate the linked chains 316, the graph generation logic 202 links the first chains 308 with the second chains 312 based on the affine loop 122. In general, the linked read dependence graph 314 includes all nodes and edges of the first read dependence graph 306, all nodes and edges of the second read dependence graph 310, and additional bi-directional edges linking data elements of the first data structure 302 with data elements of the second data structure 304.

As part of generating the linked read dependence graph 314, the graph generation logic 202 determines a chained distance vector by computing a difference between an access of the first data structure 302 in the affine loop 122 and an access of the second data structure 304 in the affine loop 122. In the example 300, the chained distance vector is representable as:

$$\vec{d} BC = ( C [ i + 1 ] [ j + 1 ] ) - ( B [ i + 1 ] [ j + 3 ] ) = ( 0 , - 2 )$$

It should be noted that the selection of operands for computation of the chained distance vector is immaterial, e.g., a chained distance vector computed based on the B[i+2] [j+4] operand and the C [i+2] [j+1] operand of the affine loop 122 produces similar results.

To generate a linked chain 316, the graph generation logic 202 selects a first chain 308 of the first read dependence graph 306. In the illustrated example 300, the graph generation logic 202 selects the first chain 308 including elements B[1,3], B[2,4], B[3,5], and B[4,6]. For each element of the selected first chain 308, the graph generation logic 202 identifies an element of the second data structure 304 based on the chained distance vector. To do so, the graph generation logic 202 accumulates an element identifier of the identified element with the chained distance vector.

By way of example, the graph generation logic 202 identifies C [1,1] based on element B[1,3] and the chained distance vector, e.g., based on accumulating the element identifier of the identified element, (1,3), with the chained distance vector, (0,−2). Moreover, the graph generation logic 202 links a second chain 312 of the second read dependence graph 310 that includes the identified element C [1,1] to the selected first chain 308 of the first read dependence graph 306. Notably, the linking is via a bi-directional edge between the selected element of the first chain 308, B[1,3], and the identified element of the second data structure 304, C [1,1], as shown.

This process is repeated on the remaining elements of the selected first chain 308 to generate the depicted linked chain 316, as shown. Although not shown for illustrative purposes, this process is similarly repeated on the remaining first chains 308 of the first read dependence graph 306 to generate additional (non-depicted) linked chains 316 of the linked read dependence graph 314.

In the illustrated example 300, the linked chain 316 is generated by selecting a first chain 308 of the first read dependence graph 306, and linking elements of the first chain 308 with second chains 312 of the second read dependence graph 310. This is because the chained distance vector, in the example 300, is based on an access of the second data structure 304, C, being subtracted from an access of the first data structure 302, B. In an alternative example, the chained distance vector is computed based on an access of the first data structure 302, B, being subtracted from an access of the second data structure 304, C. In this alternative example, a linked chain 316 is generated by selecting a second chain 312 of the second read dependence graph 310, and linking elements of the second chain 312 with first chains 308 of the first read dependence graph 306.

In one or more implementations, the linked read dependence graph 314 is further partitioned into partitioned chains 318 by applying a graph partitioning algorithm to the linked read dependence graph 314. Although just one partitioned chain 318 is depicted, it is to be appreciated that applying the graph partitioning algorithm to the linked read dependence graph 314 produces a plurality of partitioned chains 318. For example, multiple partitioned chains 318 are generated from one or more linked chains 316 of the linked read dependence graph 314.

In the illustrated example 300, the depicted partitioned chain 318 is generated by applying a depth-first traversal algorithm to the linked read dependence graph 314. However, it is to be appreciated that any suitable graph partitioning algorithm is implementable by the graph generation logic 202 to generate the partitioned chains 318 without departing from the spirit or scope of the described techniques. Example graph partitioning algorithms include a Kernighan-Lin algorithm, a spectral partitioning algorithm, and METIS partitioning algorithms.

Returning to FIG. 2, the read dependence graph 210 including the one or more chains 212 of dependent tasks is provided as input to bank locality logic 214 of the compiler 118, alignment logic 216 of the compiler 118, and duplication determination logic 218 of the compiler 118. In one or more implementations, the affine loop 122 accesses one data structure. Given this, the read dependence graph 210 corresponds to a to a non-linked read dependence graph (e.g., the first read dependence graph 306 or the second read dependence graph 310). Further, the one or more chains 212 correspond to non-linked chains of dependent elements of the one data structure (e.g., the first chains 308 or the second chains 312) and/or partitioned chains 318 as generated by applying a graph partitioning algorithm to the non-linked chains.

In one or more alternative implementations, the affine loop 122 access multiple data structures. In these implementations, the read dependence graph 210 corresponds to the linked read dependence graph 314. Further, the one or more chains 212 correspond to the linked chains 316 and/or the partitioned chains 318 as generated by applying a graph partitioning algorithm to the linked chains 316.

In accordance with the described techniques, the bank locality logic 214 is configured to determine whether the affine loop 122 is bank localizable 132. Notably, the interdependent data elements of a respective chain 212 are to be stored in a same set of bank(s) 116 operated on by one PIM unit 112. This is because read accesses of the data elements in a chain 212 rely (e.g., either directly or indirectly) on read accesses of other data elements in the chain 212 in order to process the affine loop 122. Accordingly, host-facilitated accesses of data by the PIM units 112 are invoked by storing interdependent data elements of a chain 212 in different banks 116 operated on by different PIM units 112.

Thus, in order to determine whether the affine loop 122 is bank localizable 132, the bank locality logic 214 selects a longest chain 220 of the chains 212. The longest chain 220, for instance, is a chain 212 having a highest number of interdependent data elements from among the chains 212. Further, the bank locality logic 214 compares an amount of memory 222 to store the longest chain 220 to a memory capacity 224 of the number of banks 116 to which respective ones of the PIM units 112 are communicatively coupled. In one or more implementations, the amount of memory 222 and the memory capacity 224 are measured in terms of data elements. In examples in which each PIM unit 112 operates on two banks 116, the memory capacity 224 corresponds to a number of data elements storable in two banks 116. Further, the amount of memory 222 to store the longest chain 220 corresponds to a number of interdependent data elements represented by the longest chain 220. In one or more implementations, the read dependence graph 210 is fully connected, and as such, the amount of memory 222 to store the longest chain 220 corresponds to a total number of data elements represented by the read dependence graph 210.

As shown, the bank locality logic 214 determines that the affine loop 122 is bank localizable 132 based on the memory capacity 224 being greater than or equal to the amount of memory 222. In contrast, the bank locality logic 214 determines that the affine loop 122 is not bank localizable 132, and as such, is not suitable for PIM execution 126 based on the memory capacity 224 being less than the amount of memory 222. It should be noted that different chains 212 are storable on different banks 116 operated on by different PIM units 112, while preserving bank locality.

In one or more implementations, the alignment logic 216 is configured to determine whether the affine loop 122 enables column alignment 134. Notably, a data element and the data elements to which the data element are directly connected in the read dependence graph 210 interact together (e.g., are accumulated together, multiplied together, etc.) in a single computation, e.g., in a single iteration of a loop statement. Accordingly, a set of data elements that are directly connected to a common data element in the read dependence graph 210 are to be stored in a same column of the bank(s) 116 operated on by one PIM unit 112 to enable vector processing. As previously mentioned, for instance, a PIM request invokes a PIM unit 112 to perform one or more parallel operations on different data stored in different columns of the bank(s) 116 communicatively coupled to the PIM unit 112. Given this, the interacting data elements of a single computation are processible in parallel with other sets of interacting data elements if the interacting data elements fit within a single column of the bank(s) 116.

Thus, in order to determine whether the affine loop 122 enables column alignment 134, the alignment logic 216 determines a maximum interactivity 226 of the read dependence graph 210. Practically, the maximum interactivity 226 refers to a highest number of data element elements represented by the read dependence graph 210 that interact together as part of a single computation. To determine the maximum interactivity 226, the alignment logic 216 identifies a node of the read dependence graph 210 having a highest number of nodes directly connected thereto, e.g., via incoming edges and/or outgoing edges. Here, the maximum interactivity 226 of the read dependence graph 210 corresponds to a number of nodes, including the identified node and the nodes directly connected thereto. In the example 300, for instance, the maximum interactivity 226 of the linked chain 316 is four because B[2,4], B[3,5], C [2,2], and C [3,3] are each directly connected to three other data elements of the linked chain 316.

As shown, the alignment logic 216 compares the maximum interactivity 226 to a number of rows 228 within the number of banks 116 communicatively coupled to respective ones of the PIM units 112. In an example in which each PIM unit 112 is communicatively coupled to two banks 116 and each bank 116 includes fifty rows, the number of rows 228 is one-hundred. The alignment logic 216 determines that the affine loop 122 enables column alignment 134 based on the number of rows 228 being greater than or equal to the maximum interactivity 226. In contrast, the alignment logic 216 determines that the affine loop 122 does not enable column alignment 134, and as such, is not suitable for PIM execution 126 based on the number of rows 228 being less than the maximum interactivity 226.

In accordance with the described techniques, the duplication determination logic 218 determines whether the affine loop 122 invokes a suitable amount of data duplication 136. Notably, the same data element is often represented in multiple chains 212 of the read dependence graph 210. In the example 300, for instance, one or more of the second chains 312 that are present in the depicted linked chain 316 are also present in one or more additional (non-depicted) linked chains 316. Since inter-bank communication is not enabled in various memory architectures, a data element that is present in different chains 212 is to be stored in different banks 116 operated on by different PIM units 112. In other words, the PIM architecture relies on data duplication in the memory 110 to preserve bank locality and prevent host-facilitated accesses of data by the PIM units 112. However, an excessive amount of data duplication induced by processing the affine loop 122 using the PIM units 112 renders the affine loop 122 not suitable for PIM execution 126, e.g., by way of rendering PIM-based execution of the affine loop 122 less computationally efficient than host-based execution of the affine loop 122.

Thus, in order to determine whether the affine loop 122 invokes a suitable amount of data duplication 136, the duplication determination logic 218 determines a duplication metric 230 capturing an amount of data duplication invoked in the memory 110 to execute the affine loop 122 using the PIM units 112. To do so, the duplication determination logic 218 computes a first number of data elements, including duplicated elements, represented in the read dependence graph 210. Further, the duplication determination logic 218 computes a second number of unique elements represented in the read dependence graph. In other words, the duplication determination logic 218 counts, for the first number, a duplicated element as many times as it is represented in the read dependence graph 210, while the duplicated element is counted just once for the second number. Consider an example in which the read dependence graph 210 includes a chain 212 including elements [1], [2], and [3], and an additional chain 212 including elements [2], [3], and [4]. In this example, the first number of elements is six, while the second number of unique elements is four. The duplication metric 230 is determined based on a division operation in which the first number of data elements is the numerator and the second number of unique elements is the denominator, e.g., the duplication metric is 6/4=1.5 in the described example.

In one or more implementations, the duplication determination logic 218 compares the duplication metric 230 to a duplication threshold 232. Broadly, the duplication threshold 232 represents a tolerable amount of data duplication, e.g., to enable PIM-based execution of the affine loop 122 that increases computational efficiency in relation to host-based execution of the affine loop 122. In these implementations, the duplication determination logic 218 determines that the affine loop 122 invokes a suitable amount of data duplication 136 based on the duplication metric 230 falling below the duplication threshold 232. In contrast, the duplication determination logic 218 determines that the affine loop 122 invokes an excessive amount of data duplication, and as such, the affine loop 122 is not suitable for PIM execution based on the duplication metric 230 being greater than the duplication threshold 232.

It should be noted that the linked chains 316 are typically larger (e.g., include more data elements) than the partitioned chains 318. However, the partitioned chains 318 invoke more data duplication than the linked chains 316. Thus, in one or more scenarios, the bank locality logic 214 determines that the linked read dependence graph 314 is not bank localizable 132. In response, the graph generation logic 202 further partitions the linked read dependence graph 314, and the compiler 118 re-tests the affine loop 122 for PIM suitability based on the partitioned chains 318, e.g., by determining whether the partitioned chains 318 are bank localizable 132, enable column alignment 134, and invoke a suitable amount of data duplication 136 in accordance with the described techniques.

Additionally or alternatively, the duplication determination logic 218 determines that the partitioned chains 318 invoke an excessive amount of data duplication. In response, the compiler 118 re-tests the affine loop 122 for PIM suitability based on the linked chains 316, e.g., by determining whether the linked chains 316 from which the partitioned chains 318 were generated are bank localizable 132, enable column alignment 134, and invoke a suitable amount of data duplication 136 in accordance with the described techniques.

In one or more implementations, the compiler 118 marks the affine loop 122 as suitable for PIM execution 126 based on the affine loop 122 being determined as parallelizable 130, bank localizable 132, enabling column alignment 134, and invoking a suitable amount of data duplication 136. In contrast, the compiler 118 marks the affine loop 122 as not suitable for PIM execution 126 based on the affine loop 122 being determined as not parallelizable 130, not bank localizable 132, not enabling column alignment 134, or invoking an excessive amount of data duplication 136. Although examples are described herein in which an affine loop 122 is determined as suitable for PIM execution based on parallelizability, bank locality, column alignment, and data duplication, any combination of one or more of these factors are usable for determining whether an affine loop 122 is suitable for PIM execution in variations.

Although the described techniques have been discussed in the context of determining whether code portions are suitable for offloading to the PIM units 112, it is to be appreciated that the described techniques are implementable to determine whether code portions are suitable for offloading to various types of accelerator devices. For instance, the described techniques are implementable for determining suitability of offloading a workload to any accelerator device that leverages data-level parallelism, vector processing, locality of operands, and/or data duplication for functionally correct and/or accelerated execution of workloads. One example of an accelerator device compatible with the described techniques, is an artificial intelligence (AI) accelerator, such as one or more artificial intelligence engines (AIEs).

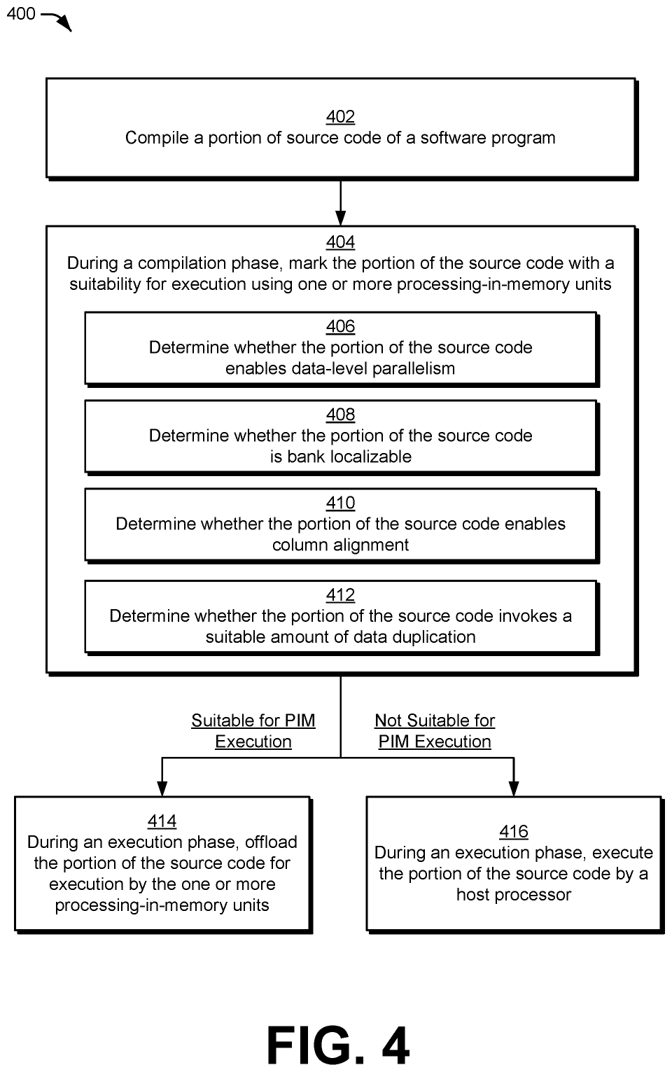

FIG. 4 depicts a procedure 400 in an example implementation of code offloading based on processing-in-memory suitability. In the procedure 400, a portion of source code of a software program is compiled (block 402). By way of example, the compiler 118 compiles the affine loop 122 of the source code 120 of the software program 114.

During a compilation phase, the portion of the source code is marked with a suitability for execution using one or more processing-in-memory units (block 404). By way of example, the compiler 118 marks the affine loop 122 with an indication of PIM suitability 124 indicating whether the affine loop is suitable for PIM execution 128 or not suitable for PIM execution 126.

As part of marking the portion of the source code, it is determined whether the portion of the source code enables data-level parallelism (block 406). By way of example, the parallelism logic 206 determines whether the affine loop 122 is parallelizable 130. To do so, the graph generation logic 202 generates the data dependence graph 204 (e.g., including nodes representing processing tasks and edges representing read dependencies and write dependencies) based on the affine loop 122. Further, the parallelism logic 206 determines whether the affine loop 122 is parallelizable 130 based on whether the data dependence graph 204 includes a cycle with a loop-carried true dependency.

As part of marking the portion of the source code, it is determined whether the portion of the source code is bank localizable (block 408). By way of example, the bank locality logic 214 determines whether the affine loop 122 is bank localizable 132. To do so, the graph generation graph generates a read dependence graph 210 representing one or more chains 212 of dependent tasks of one or more data structures accessed by the affine loop 122. In multiple data structure scenarios, the read dependence graph 210 is the linked read dependence graph 314, and the chains 212 are the linked chains 316 and/or the partitioned chains 318 as partitioned from the linked chains 316. In single data structure scenarios, the read dependence graph 210 is a non-linked read dependence graph (e.g., the first read dependence graph 306 or the second read dependence graph 310), and the chains 212 are non-linked chains (e.g., the first chains 308 or the second chains 312) and/or partitioned chains 318 as partitioned from the non-linked chains. Further, the bank locality logic 214 determines whether the affine loop 122 is bank localizable 132 based on whether the memory capacity 224 of the number of bank(s) 116 communicatively coupled to respective ones of the PIM units 112 is greater than or equal to an amount of memory 222 to store a longest chain 220 of the chains 212.

As part of marking the portion of the source code, it is determined whether the portion of the source code enables column alignment (block 410). By way of example, the alignment logic 216 determines whether the affine loop 122 enables column alignment 134. To do so, the alignment logic 216 determines a maximum interactivity 226 of the read dependence graph 210, e.g., a highest number of directly interconnected data elements of the read dependence graph 210. Further, the alignment logic 216 determines whether the affine loop 122 enables column alignment based on whether a number of rows 228 in the number of bank(s) 116 communicatively coupled to respective ones of the PIM units 112 is greater than or equal to the maximum interactivity 226.

As part of marking the portion of the source code, it is determined whether the portion of the source code invokes a suitable amount of data duplication (block 412). By way of example, the duplication determination logic 218 determines whether the affine loop 122 invokes a suitable amount of data duplication 136. To do so, the duplication determination logic 218 counts a first number of data elements, including duplicated elements, represented by the read dependence graph 210. Further, the duplication determination logic 218 counts a second number of unique data elements represented by the read dependence graph 210. A duplication metric 230 is determined based on a division operation in which the first number is the numerator and the second number is the denominator. The duplication determination logic 218 determines whether the affine loop 122 invokes the suitable amount of data duplication 136 based on the duplication metric 230 falling below the duplication threshold 232.

In one or more implementations, the portion of the source code is marked as suitable for PIM execution 128 based on the portion of the source code being parallelizable 130, bank localizable 132, enabling column alignment 134, and invoking the suitable amount of data duplication 136. In these implementations, the portion of the source code is offloaded, during an execution phase, for execution by the one or more processing-in-memory units (block 414). For example, the host processor 104 offloads the affine loop 122 for execution by the PIM units 112 based on the affine loop 122 being marked as suitable for PIM execution 128.

In one or more alternative implementations, the portion of the source code is marked as not suitable for PIM execution 126 if the portion of the source code is not parallelizable 130, not bank localizable 132, does not enable column alignment 134, or invokes an excessive amount of data duplication. In these implementations, the portion of the source code is executed, during an execution phase, by a host processor (block 416). For example, the host processor 104 executes the affine loop 122 based on the affine loop 122 being marked as not suitable for PIM execution 126.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 102, host processor 104, the core 106, the PIM units 112, the graph generation logic 202, the parallelism logic 206, the bank locality logic 214, the alignment logic 216, and the duplication determination logic 218) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A device, comprising:
a memory that includes one or more processing-in-memory units;
a processor core; and
a compiler executing on the processor core, the compiler causing the processor core to perform operations including:
compiling source code of a software program;
during the compiling, marking a portion of the source code as suitable for execution using the one or more processing-in-memory units; and
offloading the portion of the source code for execution by the one or more processing-in-memory units based on the marking.

2. The device of claim 1, the operations further including generating a data dependence graph based on the portion of the source code, wherein the marking is based on an absence of cycles in the data dependence graph that include at least one loop-carried true dependency.

3. The device of claim 2, wherein a cycle includes the at least one loop-carried true dependency based on a read access that is performed during a subsequent iteration of the cycle being dependent on a write access that is performed during a previous iteration of the cycle.

4. The device of claim 1, wherein the portion of the source code accesses a first data structure and a second data structure, the operations further including:
generating a first read dependence graph representing one or more first chains of dependent elements of the first data structure based on the portion of the source code;
generating a second read dependence graph representing one or more second chains of dependent elements of the second data structure based on the portion of the source code; and
generating a linked read dependence graph representing one or more linked chains of dependent elements by linking the one or more first chains with the one or more second chains based on the portion of the source code.

5. The device of claim 4, wherein the marking is based on a memory capacity of a first number of banks communicatively coupled to respective ones of the one or more processing-in-memory units being greater than or equal to an amount of the memory to store a second number of elements represented by a longest chain of the one or more linked chains.

6. The device of claim 4, wherein the marking is based on a duplication metric falling below a threshold, the duplication metric capturing an amount of data duplication in the memory to execute the portion of the source code using the one or more processing-in-memory units.

7. The device of claim 6, the operations further including computing the duplication metric based on a comparison of a first number of elements, including duplicated elements, represented by the linked read dependence graph to a second number of unique elements represented by the linked read dependence graph.

8. The device of claim 4, wherein the marking is based on a first number of rows in a second number of banks communicatively coupled to respective ones of the one or more processing-in-memory units being greater than or equal to a maximum number of interacting elements of the linked read dependence graph.

9. The device of claim 8, wherein the maximum number of interacting elements includes an element of the linked read dependence graph and one or more elements directly connected to the element in the linked read dependence graph, the element having a highest number of elements directly connected thereto in the linked read dependence graph.

10. The device of claim 1, the operations further including:
during the compiling, marking an additional portion of the source code as not suitable for execution using the one or more processing-in-memory units; and
executing the portion of the source code based on the portion of the source code being marked as not suitable for execution using the one or more processing-in-memory units.

11. A method, comprising:
compiling a portion of source code of a software program;
during the compiling, generating a read dependence graph representing one or more chains of dependent elements of one or more data structures accessed by the portion of the source code; and
offloading the portion of the source code for execution by one or more processing-in-memory units based on a memory capacity of a number of banks communicatively coupled to respective ones of the one or more processing-in-memory units being greater than or equal to an amount of memory to store a number of elements represented by a longest chain of the one or more chains.

12. The method of claim 11, wherein the portion of the source code accesses a first data structure and a second data structure, wherein generating the read dependence graph includes:
generating a first read dependence graph representing one or more first chains of dependent elements of the first data structure based on the portion of the source code;
generating a second read dependence graph representing one or more second chains of dependent elements of the second data structure based on the portion of the source code; and
generating the read dependence graph representing the one or more chains of dependent elements by linking the one or more first chains with the one or more second chains based on the portion of the source code.

13. The method of claim 11, further comprising computing a duplication metric capturing an amount of data duplication in the memory to execute the portion of the source code using the one or more processing-in-memory units, wherein offloading the portion of the source code is further based on the duplication metric falling below a threshold.

14. The method of claim 13, wherein the duplication metric is based on a comparison of a first number of elements, including duplicated elements, represented by the read dependence graph to a second number of unique elements represented by the read dependence graph.

15. The method of claim 11, further comprising:
generating a data dependence graph based on the portion of the source code; and
verifying an absence of cycles in the data dependence graph that include at least one loop-carried true dependency, wherein offloading the portion of the source code is further based on the verifying.

16. The method of claim 15, wherein a cycle includes the at least one loop-carried true dependency based on a read access that is performed during a subsequent iteration of the cycle being dependent on a write access that is performed during a previous iteration of the cycle.

17. The method of claim 11, further comprising verifying that an additional number of rows in the number of banks is greater than or equal to a maximum number of elements that are operated on together in a single computation of the portion of the source code based on the read dependence graph, wherein offloading the portion of the source code is further based on the verifying.

18. A system, comprising;
a memory that includes one or more processing-in-memory units; and
a processor core to perform operations including:
compiling a portion of source code of a software program;
during the compiling, computing a duplication metric capturing an amount of data duplication in the memory to execute the portion of the source code using the one or more processing-in-memory units; and
offloading the portion of the source code for execution by the one or more processing-in-memory units based on the duplication metric falling below a threshold.

19. The system of claim 18, wherein the portion of the source code accesses at least one data structure, the operations further including:
generating a read dependence graph representing one or more first chains of dependent elements of the at least one data structure based on the portion of the source code; and
generating, using a graph partitioning algorithm, one or more second chains of dependent elements of the at least one data structure by partitioning the one or more first chains.

20. The system of claim 19, wherein computing the duplication metric is based on a comparison of a first number of elements, including duplicated elements, represented by the one or more second chains to a second number of unique elements represented by the one or more second chains.
